(19) United States
(12) Patent Application Publication
(10) Pub. No.: US 2022/0405803 A1
(43) Pub. Date: Dec. 22, 2022

(54) SYSTEMS AND METHODS FOR PROVIDING INCENTIVE-BASED MESSAGES ON A VEHICLE EXTERIOR

(71) Applicant: BlueOwl, LLC, San Francisco, CA (US)

(72) Inventors: Theobolt N. Leung, San Francisco, CA (US); Kenneth Jason Sanchez, San Francisco, CA (US); Tina Fang, San Jose, CA (US)

(21) Appl. No.: 16/795,113

(22) Filed: Feb. 19, 2020

(51) Int. Cl. G06Q 30/02

(52) U.S. Cl. CPC G06Q 30/0265; G06Q 30/0224; G06Q 30/0261; G06Q 30/0212

(57) ABSTRACT

An electronic device for providing incentive-based messages on a surface of a vehicle is presented. The device comprises a transceiver; one or more memories; and one or more processors interfacing with the transceiver, the one or more memories, and the electronic display. The one or more processors is configured to obtain a set of vehicle profile data corresponding to the vehicle, and determine a set of user devices configured to receive a notification corresponding to an incentive-based message. The processors also determine an incentive-based message based at least in part upon the vehicle profile data and the set of user devices, and transmit the incentive-based message to the vehicle and the notification to the set of user devices. The processors also cause an electronic display disposed on the surface to display the incentive-based message for viewing by a set of individuals associated with the set of user devices.

### FIELD OF THE DISCLOSURE

The present disclosure generally relates to incentive-based messages and, more particularly, to a system and method for providing incentive-based messages on the exterior of a vehicle for viewing by proximate users of a shared application or other network environment.

### BACKGROUND

Businesses and advertising entities have long sought to entice potential and return customers alike with incentive-based advertising. Such advertising typically incentivizes consumer participation by providing a discount, free item, or other beneficial transaction during a relatively short timeframe, as specified in the advertisement. Moreover, conventional advertising methods designed for motorists or vehicular passengers centered around roadside billboards. Thus, incentive-based advertising for motorists or other vehicular passengers is conventionally placed on roadside billboards.

However, incentive-based advertising on roadside billboards suffers from several drawbacks. First, conventional billboards (digital and analog) lack readability because they are displaced away from the roadway, and consequently, the motorists/passengers attempting to view them. Thus, conventional billboards are unable to effectively communicate the messages contained therein. Second, conventional billboards suffer from an increased distraction potential for motorists due to their displacement. Accordingly, conventional billboards may result in a higher risk of traffic accidents by diverting motorist attention away from the active roadway. Third, conventional billboards suffer from a lack of relevant and timely message displays to accommodate shifting interests/priorities of those viewing the message displays and the time-sensitive nature of incentive-based messages.

### SUMMARY

In one embodiment, a system for displaying incentive-based messages on a surface of a vehicle may be provided. The device may comprise a transceiver; one or more memories; and one or more processors interfacing with the transceiver, the one or more memories. The one or more processors may be configured to: obtain a set of vehicle profile data corresponding to the vehicle; determine a set of user devices configured to receive a notification corresponding to an incentive-based message based at least in part upon a respective distance of each user device from the vehicle; determine an incentive-based message based at least in part upon the vehicle profile data and the set of user devices; transmit the incentive-based message to the vehicle; transmit the notification to the set of user devices; and cause an electronic display disposed on the surface to display the incentive-based message for viewing by a set of individuals associated with the set of user devices.

In another embodiment, a computer-implemented method for displaying incentive-based messages on a surface of a vehicle may be provided. The method may comprise obtaining, by one or more processors, a set of vehicle profile data corresponding to the vehicle; determining, by the one or more processors, a set of user devices configured to receive a notification corresponding to an incentive-based message based at least in part upon a respective distance of each user device from the vehicle; determining, by the one or more processors, an incentive-based message based at least in part upon the vehicle profile data and the set of user devices; transmitting, by the one or more processors via a transceiver, the incentive-based message to the vehicle; transmitting, by the one or more processors via the transceiver, the notification to the set of user devices; and displaying, by an electronic display disposed on the surface, the incentive-based message for viewing by a set of individuals associated with the set of user devices.

In yet another embodiment, a computer readable storage medium comprising non-transitory computer readable instructions stored thereon for displaying incentive-based messages on a surface of a vehicle may be provided. The instructions when executed on one or more processors may cause the one or more processors to obtain a set of vehicle profile data corresponding to the vehicle; determine a set of user devices configured to receive a notification corresponding to an incentive-based message based at least in part upon a respective distance of each user device from the vehicle; determine an incentive-based message based at least in part upon the vehicle profile data and the set of user devices; transmit the incentive-based message to the vehicle; transmit the notification to the set of user devices; and cause an electronic display disposed on the surface to display the incentive-based message for viewing by a set of individuals associated with the set of user devices.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 illustrates an example system for facilitating incentive-based advertising on automobiles;

FIG. 2 illustrates another example system for facilitating incentive-based advertising on automobiles;

FIG. 3 depicts an operational embodiment of, for example, the system of FIG. 2;

FIG. 4 is a flowchart depicting an example method corresponding to various embodiments of the present disclosure.

### DETAILED DESCRIPTION

### I. Example System and Related Functionality for Providing Incentive-Based Messages on Automobiles

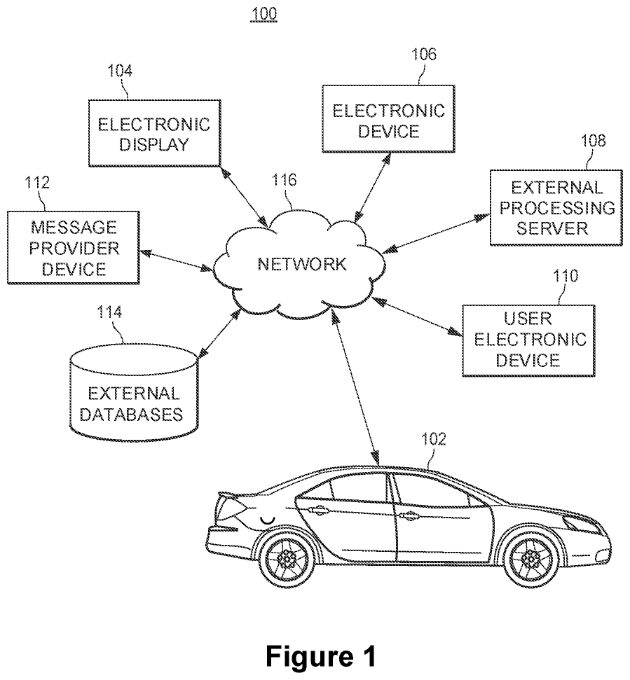

FIG. 1 illustrates an example system 100 for facilitating incentive-based advertising on automobiles. The example system 100 may include a vehicle 102, an electronic display 104, an electronic device 106, an external processing server 108 (also referenced herein as an “auction host server”), a user electronic device 110 (also referenced herein as a “user device”), a message provider device 112, external databases 114, and a network 116. While illustrated in FIG. 1 as a single external database, in some embodiments the external databases 114 includes two or more external databases. The network 116 may be a computer network of an insurance provider (e.g., provided or used by the insurance provider or communications over which the insurance provider otherwise controls or facilitates).

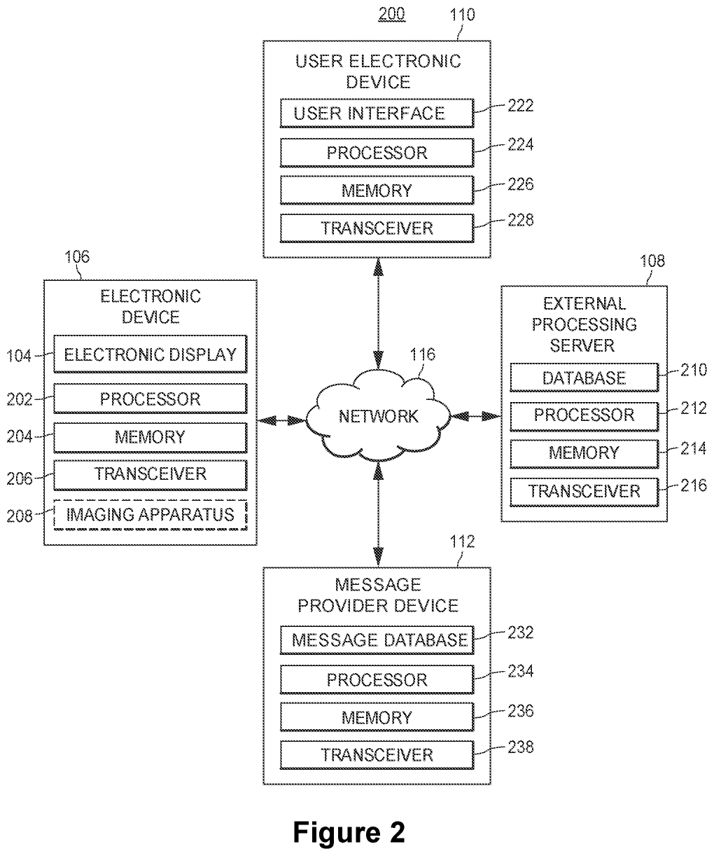

FIG. 2 illustrates another example system for facilitating incentive-based advertising on automobiles. In reference to the example system 200 of FIG. 2, the electronic device 106 may include the electronic display 104, a processor 202, a memory 204, a transceiver 206, and an optional imaging apparatus 208. While referred to herein as a “processor” and a “memory,” in some embodiments the processor 202 includes two or more processors and the memory 204 includes two or more memories. The processor 202 may be configured to analyze both still image data and video data (e.g., video data received by the transceiver 206) and analyze aspects of the still image data and/or video data. The memory 204 may store computer-executable instructions, which may be executed by the processor 202.

It should be understood that the electronic display 104 may be either an external, standalone device or an internal component of the electronic device 106. In other words, in embodiments, the electronic display 104 may be a standalone entity affixed to a surface of a vehicle (e.g., vehicle 102). In that case, the electronic display 104 may have a processor, memory, imaging assembly, transceiver, etc. and be configured to receive an incentive-based message from the electronic device 106, external processing server 108, the message provider device 112, and/or any other suitable transmitter or combination thereof (e.g., external databases 114).

The optional imaging apparatus 208 may include, for example, an image sensor (e.g., a camera, a video camera), and/or a proximity sensor. As such, the optional imaging apparatus 208 may be configured to capture still images, video footage, proximity information (e.g., indicative of distances to/from imaging apparatus). However, it should be understood that the optional imaging apparatus 208 is not limited to the sensors disclosed herein. Additionally, the electronic device 106 may be configured to receive communications from the external processing server 108, the user electronic device 110, the message provider device 112, and/or other suitable transmitters (e.g., external databases 114) in response to transmitting captured data and/or before, during, or after displaying an incentive-based message.

The external processing server 108 may include a database 210, a processor 212, a memory 214, and a transceiver 216. While referred to herein as a “processor” and a “memory,” in some embodiments the processor 212 includes two or more processors and the memory 214 includes two or more memories. The processor 212 may be configured to process both still image data and video data (e.g., video data received from the electronic device 106) and analyze aspects of the still image data and/or video data. The memory 214 may store computer-executable instructions, which may be executed by the processor 212. The database 210 may include message display profiles. The message display profiles may correspond to a set of information associating a vehicle with certain message display characteristics and/or priorities. For example, a message display profile may indicate that a particular vehicle (e.g., vehicle 102) may consistently drive in low population density areas, and may further drive in those areas late at night. As further discussed herein, based at least in part upon the message display profile, the external processing server 108 may determine incentive-based messages for display on the electronic display 104 and/or auction rates corresponding to the vehicle 102. The message display profiles may also correspond with insured user profiles/accounts, insurance policies, or other user profiles, accounts, policies, etc.

Further, the message display profile may include relevant data associated with a user indicated in the message display profile. For example, if a message display profile is an insurance policy listing a first user as the insured, the insurance policy may list the first user's name, age, gender, etc. Moreover, and as discussed further herein, the relevant data may include multiple profile features associated with each message display profile. These profile features may, for example and as discussed further herein, facilitate incentive-based message display on a vehicle 102 by allowing the external processing server 108 to develop a broader knowledge base with which to determine the incentive-based messages for display.

The user electronic device 110 may include a user interface 222, a processor 224, a memory 226, and a transceiver 228. While referred to herein as a “processor” and a “memory,” in some embodiments the processor 224 includes two or more processors and the memory 226 includes two or more memories. In embodiments, the user electronic device 110 may execute computer-executable instructions, such as a mobile application, that allow some of the actions described herein to be implemented. For example, if the user electronic device 110 is a smartphone, the user may receive data from the external processing server 108 via the transceiver 228 for display on the user interface 222. The user electronic device 110 may then transmit the data through the network 114 to the message provider device 112, the electronic device 106, and/or the external processing server 108 for processing. The user electronic device 110, and each of the computing devices referred to herein, may be any suitable computing device such as, but not limited to, a desktop computer, a laptop computer, a mobile phone such as a smart phone, a tablet, a phablet, smart glasses, other wearable computing device(s), etc. It will be appreciated that the user electronic device 110 may be located in a different vehicle than the electronic device 106.

The system 200 further includes the message provider device 112. The message provider device 112 includes a message database 232, a processor 234, a memory 236, and a transceiver 238. While referred to herein as a “processor” and a “memory,” in some embodiments the processor 234 includes two or more processors and the memory 236 includes two or more memories. The message database 232 may include a set of messages for display, for example, on the electronic display 104 disposed on a surface of the vehicle 102 and/or the user interface 222 of the user electronic device 110.

The message provider device 112 may be connected to each of the electronic device 106, the external processing server 108, and the user electronic device 110 via the network 116, such that all devices (e.g., 106, 108, 110, and 112) may communicate to each other via their respective transceivers (e.g., 206, 216, 228, and 238). For example, the external processing server 108 may receive updated message display profile information from the electronic device 106. The external processing server 108 may store this received information in its database 210 and/or its memory 214. Thus, and as discussed further herein, the external processing server 108 may be configured to process, analyze, or otherwise interpret data captured by and/or received from the electronic device 106. Moreover, the message provider device 112 may transmit incentive-based message data to the electronic device 106, the external processing server 108, and/or the user electronic device 110 through the network 116. The device 106, server 108, and/or device 110 may receive the targeted message and store it in memory 204, 214, 226 and/or further transmit the targeted message to the electronic device 106, electronic display 104, and/or device 110 for display. It will be appreciated that the external processing server 108 and/or message provider device 112 may be a server and/or device provided by or used by an insurance provider, or use of which the insurance provider otherwise controls or facilitates.

In embodiments, the network 116 may be or may include a network such as the Internet and/or any other type of suitable network (e.g., a local area network (LAN), a metropolitan area network (MAN), a wide area network (WAN), a mobile network, a wired or wireless network, a private network, a virtual private network, etc.). The network 116 may also or alternatively be or include one or more cellular networks such as code division multiple access (CDMA) network, GSM (Global System for Mobile Communications) network, WiMAX (Worldwide Interoperability for Microwave Access) network, Long Term Evolution (LTE) network, etc.

As further described below, the example systems (e.g., 100, 200) facilitate incentive-based message display on automobiles, and allow, among other advantages, readable messages that have a limited distraction potential for motorists and are relevant to those viewing the messages. The messages displayed on the systems described herein are more readable than those of conventional digital displays because the messages are displayed on vehicles that are closer to both pedestrians and proximate vehicles than the conventional display devices (e.g., billboards). Placing the targeted messages on proximate vehicles reduces distraction potential for other motorists and pedestrians alike because the messages keep their focus nearer to their local surroundings (e.g., active roadways, sidewalks, crosswalks, etc.) instead of the elevated positions of conventional display devices that remove their focus from such surroundings. Hence, the systems of the present application are able to effectively communicate the incentive-based messages, and may reduce the risk of traffic accidents and other roadway hazards by eliminating the distracting potential of conventional display devices. The messages are also more relevant than the static, general messages on conventional display devices because they are dynamically updated and targeted for the proximate viewing audience (e.g., proximate motorists and pedestrians).

In this manner, and as will be further discussed herein, the systems of the present application provide a technical improvement to the field of roadway message display. The systems provide a real-time message delivery system capable of determining an incentive-based message related to proximate drivers, pedestrians, and/or other users or combinations thereof. Accordingly, the systems of the present application readily and effectively incorporate and present time-sensitive messages (e.g., incentive-based messages) in a format and display location that is both relevant and proximate to users. Thus, the systems and methods of the present application also improve the functioning of the devices used to facilitate the above-described advantages. For example, user electronic devices utilizing the systems and methods of the present application may dynamically request notifications, receive notifications, transmit successful requests, and/or receive benefits associated with an incentive-based message displayed in accordance with the systems and methods of the present application, or any combination thereof, to achieve a more active/responsive connection with external devices regarding the exchange of incentive-based message communications.

### II. Example Operational Embodiments of the System

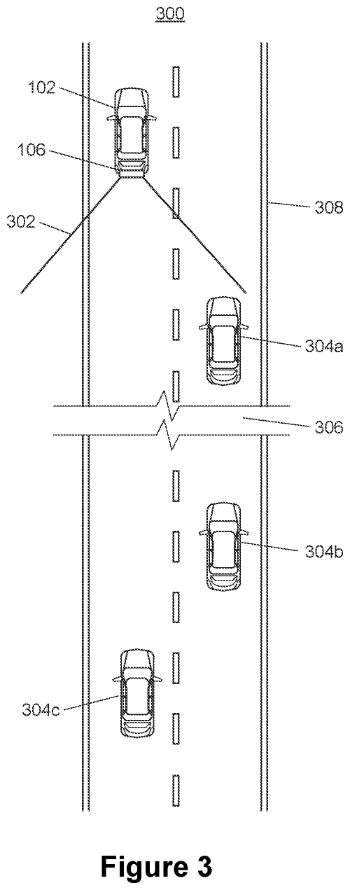

FIG. 3 depicts an operational embodiment 300 of, for example, the system 200. The operational embodiment 300 includes the vehicle 102 and the electronic device 106. The electronic device 106 includes a field of view (FOV) 302 indicating an area where the device's 106 sensors (e.g., optional imaging apparatus 208) are capable of capturing data (e.g., environmental data). In embodiments, the vehicle 102 may have a sensor or sensors surrounding its exterior and thus may have an effective FOV 302 corresponding to the entire surrounding environment of the vehicle or any portion of the surrounding environment therein. Moreover, and as discussed further herein, the FOV 302 may have a range of any suitable degree to capture the environmental data. For example, the device's 106 sensors may be disposed at a plurality of locations around the vehicle 102 such that the entire environment (e.g., 360° view surrounding the vehicle 102) is captured to yield environmental data.

The operational embodiment 300 further includes a set of vehicles 304a, 304b, and 304c. Vehicle 304a is inside the FOV 302, and vehicles 304b and 304c are outside the FOV 302 and some distance 306 away from the vehicle 102. For example, the vehicles 304b, 304c may be traveling on the same roadway 308 as the vehicle 102, or they may be on any other roadway. Moreover, the vehicles 304b, 304c may be any distance behind the vehicle 102, or at any other location with respect to the vehicle 102. For example, the vehicles 304b, 304c may be 500 feet ahead of the vehicle 102.

The electronic device 106 may correspond with an external server (e.g., external processing server 108, message display server 112) or other device (e.g., user electronic device 110) to request and/or receive an incentive-based message for display. Generally speaking, the device 106 may transmit a request for an incentive-based message for display to proximate vehicles (e.g., vehicle 304a), pedestrians, and/or other viewing entities. The request may include data such as a vehicle profile, indicating, for example, the make, model, year, color, etc. of the vehicle 102 and/or any other suitable information or combination thereof. The external server or other device that receives the request from the device 106 may perform an analysis of the area surrounding the vehicle 102 to determine users of an application, platform, or other service that facilitate the incentive-based message functionality described herein. For example, the request receiving device may check user devices within a 1 mile radius of the vehicle 102 to determine which user devices are active and have a specific application downloaded (e.g., the State Farm® “Drive Safe and Save Application) for which the receiving device either has or may generate a corresponding incentive-based message. In response to determining that there is a user device with a suitable application, platform, or other suitable service within the appropriate viewing range of the vehicle 102, the receiving device may generate and transmit a signal to the device 106 containing the incentive-based message for display. Accordingly, the device 106 may receive the transmitted signal containing the incentive-based message, and may display the incentive-based message on the electronic display 104.

Further, and as described herein, the receiving device may additionally transmit a notification to the user devices which are within the appropriate viewing range of the vehicle 102. The notification may indicate, for example, that the user associated with the user device has a particular period of time to locate and view the incentive-based message. The notification may also indicate that, should the user successfully locate and view the incentive-based message, the user will receive a specified benefit corresponding to the incentive-based message.

In embodiments, the electronic device 106 may capture data corresponding to the environment associated with the vehicle 102. More specifically, the electronic device 106 may capture (e.g., via the optional imaging apparatus 208) image/video data corresponding to the environment surrounding the vehicle 102 as it travels along the roadway 308. Based at least in part upon this acquired information, the electronic device 106 may determine that a vehicle (e.g., vehicle 304a) is within an appropriate viewing distance of the electronic device 106 to receive an incentive-based message. The device 106 may make this determination with a depth imaging system, a distance and ranging device, or any other suitable instrumentation.

Moreover, the device 106 may acquire the data corresponding to the vehicle 102 environment, determine that a vehicle is within an appropriate viewing distance, and other functionality described herein on any suitable timeframe. For example, the device 106 may periodically (e.g., every several seconds, minutes, hours, days, weeks, etc.) acquire and analyze the data corresponding to the vehicle 102 environment, and/or may perform these functions upon user request. Additionally, the device 106 may perform the acquisition and analysis functions upon a user's acceptance of an offer to display an incentive-based message. For example, the external processing server 108, user electronic device 110, and/or the message provider device 112 may periodically or upon receipt of data indicative of an opportune moment to provide an incentive-based message transmit a push notification or other indication of such incentive-based message to the electronic device 106. The electronic device 106 may display such notification to a user directly, or may further transmit such notification to the user's vehicle (e.g., vehicle 102) for display on an internal user interface associated with the vehicle 102.

In any event, in these embodiments, the electronic device 106 may request, via the transceiver 206, an incentive-based message from the external processing server 108 or the message provider device 112 once the electronic device 106 determines that a vehicle (e.g., vehicle 304a) or other application user (e.g., pedestrians, cyclists, etc.) is within an appropriate viewing range of the electronic display 106. For example, the vehicle 102 may be traveling along residential street (e.g., roadway 308), and the vehicle 304a may be following along the street with a set of individuals (not shown) on nearby sidewalks/crosswalks. Thus, when the electronic device 106 captures data corresponding to the vehicle 102 environment, the vehicle 304a occupants and the set of individuals may be included in the data because they are inside the FOV 302.

In embodiments, any of the vehicle 304a or any individual of the set of individuals may be far enough away from the vehicle 102 to be outside the FOV 302. Moreover, the electronic device 106 may make the determination of what objects fall within the FOV 302 by comparing the determined distances from the vehicle 102 for each detected object (e.g., vehicle 304a, and each individual of the set of individuals) to a threshold distance value. Any determined distance that exceeds the threshold distance value may cause the object associated with the determined distance to be excluded from the subsequent determination of an incentive-based message, as described further herein. Nevertheless, as the vehicle 102 drives along the street, the vehicle 304a, vehicles 304b, 304c, and/or any individual of the set of individuals may eventually come into the FOV 302 and be included in the analysis for determining an incentive-based message, in accordance with various embodiments and as discussed further herein.

Additionally in these embodiments, after the electronic device 106 captures the data corresponding to the vehicle 102 environment, the device 106 may determine demographic data from the data. The demographic data may be indicative of an occupant of the vehicle 304a or an individual of the set of individuals, such that analyzing the data will facilitate determining an incentive-based message. Thus, after analyzing the demographic data, the external processing server 108 may determine an incentive-based message, and transmit the incentive-based message to the electronic device 106 for display. Accordingly, the vehicle 304a occupant and/or an individual of the set of individuals may view the incentive-based message via the electronic device 106, and more particularly, via the electronic display 104.

Moreover, any individuals or vehicle occupants who are outside the FOV 302 (e.g., vehicle 304b, 304c occupants) may also view the incentive-based message if the vehicle occupant or individual is in a position where viewing the message may be possible (e.g., in this embodiment, behind the vehicle 102). Thus, if the vehicle occupant or individual comes into the FOV 302 during the display period of an incentive-based message, that vehicle occupant or individual may receive a push notification or other indication that the incentive-based message is currently being displayed on the electronic device 106. By interacting with or otherwise acknowledging the push notification or other indication of the presence of the incentive-based message, the vehicle occupant or other individual may be able to obtain the benefits associated with locating and viewing the incentive-based message, as described further herein.

### III. Example of a Method for Providing Incentive-Based Messages on Automobiles

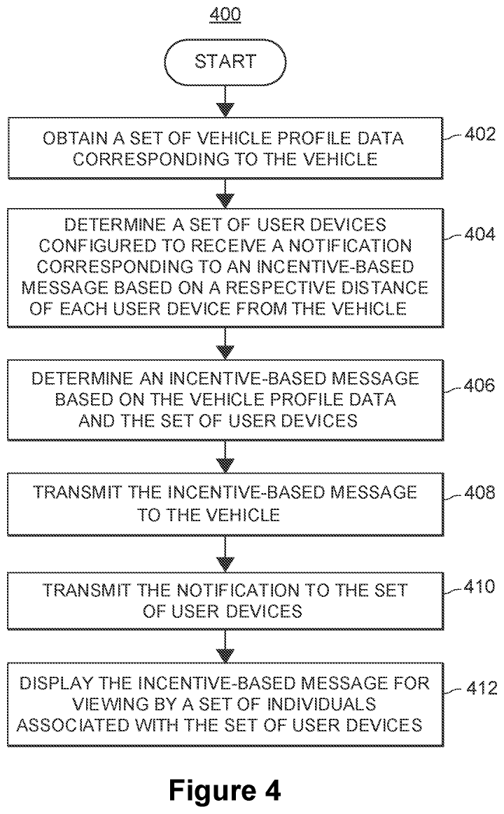

FIG. 4 is a flowchart depicting an example method 400 corresponding to various embodiments of the present disclosure. The method 400 begins at block 402 where, for example, a computer processor (e.g., electronic device 106) obtains a set of vehicle profile data corresponding to the vehicle (e.g., vehicle 102). The set of vehicle profile data may include information such as the vehicle make, model, year, color, vehicle identification number (VIN), etc. and/or any other suitable vehicle information or combination thereof. In embodiments, the set of vehicle profile data may include at least one of (i) a set of telematics data, (ii) a current route, (iii) a driving behavior pattern, (iv) an historical route, (v) a geographical location, (vi) a set of current traffic information, (vii) a set of historical maintenance records, (viii) a set of current weather conditions, (ix) a weather forecast, (x) a current date, or (xi) a current time. For example, the set of vehicle profile data may indicate that the corresponding vehicle is a 2015 black sedan, and that the vehicle is being driven on an interstate highway at approximately 60 miles per hour (mph) at 5:00 PM. The set of vehicle profile data may also indicate that the 2015 black sedan is typically driven at or below the posted speed limit, and that the routes taken by the vehicle are through low speed traffic regions. Moreover, the set of vehicle data may indicate a set of individuals associated with the vehicle (e.g., a driver, owner, and/or insured user). Block 402 may be performed by, for example, the electronic device 106.

The method 400 continues at block 404 by determining a set of user devices configured to receive a notification corresponding to an incentive-based message based at least in part upon a respective distance of each user device from the vehicle. For example, the set of vehicle profile data may contain a location of the vehicle. Using this location as an origin, a server may conduct an analysis of a region surrounding the vehicle. The region surrounding the vehicle may, for example, extend 1 mile radially from the vehicle corresponding to the vehicle profile data. Moreover, the server, when conducting the region analysis, may update the region of interest surrounding the vehicle to account for the movement of the vehicle. To illustrate, assume the vehicle is traveling along an interstate highway at 60 mph. Thus, every minute, the vehicle will travel 1 mile, such that any region analyzed by the server more than one minute ago will be largely irrelevant. Accordingly, the server may perform a real-time or otherwise dynamically updated region analysis to determine a set of proximate user devices configured to receive a user notification corresponding to an incentive-based message. Block 404 may be performed by, for example, the external processing server 108 and/or the message provider server 112.

The region analysis performed by the server may include contacting detected user devices to probe for relevant information. For example, the server may request a listing of applications installed on the user device. Moreover, in embodiments, the server may request access to the user device to determine which applications are currently active on the user device, or to determine which applications are frequently accessed on the user device. Further, and as discussed further herein, the server may aggregate the identified applications from multiple queried user devices to determine a prioritized list of potential incentive-based messages for display on the vehicle. In this manner, the server may more intelligently determine an incentive-based message by tailoring the displayed message to the determined interests and/or priorities of the user(s) of the user device(s).

To illustrate, and in embodiments, each queried user device may include a set of user device data. The sets of user device data may include at least one of (i) a vehicle type, (ii) a user name, (iii) a user age, (iv) a user gender, and/or (v) a user weight; any combination thereof; and any other suitable data. For example, a set of user device data may indicate that the user of the queried user device drives a pickup truck and is 30 years old. The set of user device data may additionally indicate that the user is 6 feet tall and that the user device is 3 years old. Using this data, the systems and methods of the present disclosure may more accurately provide incentive-based messages that rely on both application information from a user device as well as data associated with the user to generate incentive-based messages that may appeal and/or otherwise be relevant to the user of the queried user device.

Moreover, broadly speaking, the server may now determine an incentive-based message based at least in part upon two independent sets of information. Namely, the server may determine an incentive-based message based at least in part upon both the vehicle profile data and the user device data. The server may infer or otherwise determine an appropriate message based at least in part upon what the user of a queried user device may prefer to view, and based at least in part upon what the vehicle associated with the vehicle profile data is configured to show.

As previously mentioned, determining the set of user devices may include the computer processor receiving data corresponding to the environment of the vehicle. In embodiments, the computer processor may receive the environmental data from one or more of (i) vehicle-to-vehicle (V2V) communication protocols, (ii) vehicle-to-infrastructure (V2I) communication protocols, or (iii) one or more mobile devices. For example, the computer processor may communicate, via the transceiver 208, with other vehicles (e.g., vehicle 304a) to determine environmental data concerning the vehicle 304a and its occupants. The computer processor may receive data such as the year, make, model, VIN of the vehicle 304a, and/or any associated user information linked with the vehicle 304a data. As one example, the data received from the vehicle 304a may be associated with an insurance policy covering the vehicle 304a. The vehicle (e.g., vehicle 102) may access this insurance policy and extract other information from the policy that may be relevant. The policy may indicate, inter alia, covered drivers for the automobile and basic identifying information for those drivers (e.g., name, age, sex, driving experience, license number, license issuing state, etc.). As discussed further herein, the external processing server 108 may receive and use such information when determining an incentive-based message for display on an electronic device, and more specifically, the electronic display 104.

In embodiments, and as previously discussed, determining the set of user devices may further include capturing data associated with the vehicle (e.g., vehicle 102) environment, via an imaging apparatus (e.g., optional imaging apparatus 208). The imaging apparatus may include an image sensor, and the image sensor may be configured to capture a set of digital images. The set of digital images may be included in or otherwise comprise the data associated with the vehicle environment. To illustrate, the imaging apparatus may capture a set of digital images featuring a proximate vehicle (e.g., vehicle 304a) and a set of individuals. The imaging apparatus may capture the set of digital images in response to detecting that at least one entity is within the FOV of the imaging apparatus (e.g., FOV 302), and/or in response to the proximity sensor or any other sensor included in the imaging apparatus detecting the presence of at least one entity within the FOV.

Moreover, the device may use any of a number of extraction techniques to extract data associated with the detected object from the data associated with the vehicle environment. For example, the device may utilize (i) facial recognition, (ii) object recognition (OR), (iii) object character recognition (OCR), and/or any other suitable extraction technique. Moreover, the device may incorporate other relevant features into the data associated with the detected object. For example, the device may include (i) a location of the vehicle, (ii) a time when the image sensor captured the set of digital images, (iii) an age of a respective individual of the set of individuals, (iv) a gender of the respective individual, (v) a height of the respective individual, (vi) a weight of the respective individual, and/or any other suitable data or combination thereof.

As an illustration, the electronic device may capture data associated with the vehicle environment and detect that at least one entity is within the FOV of the imaging apparatus. The data may include a location of the vehicle (e.g., an address associated with an elementary school) and a time when the vehicle is at the location (e.g., 3:00 pm on a Wednesday during the school year). The electronic device may also detect several individuals within the capture data, and that several individuals are relatively shorter (e.g., under 5′ tall) than several other individuals (e.g., each over 5′ tall). Thus, using all of this data, the external processing server may determine that the vehicle is in an elementary school carpool line, and that several of the individuals located in the electronic device's FOV are children.

The proximity sensor may be configured to capture a set of proximity data. The proximity data may be indicative of a set of distances from the vehicle to the proximate entities. To illustrate, the proximity sensor may capture a set of proximity data indicative of a set of distances from the vehicle for the proximate vehicle. The proximity sensor may further determine that the proximate vehicle is 10 feet from the vehicle. Additionally, the proximity sensor may determine that the proximate vehicle is 10 feet from the right rear panel of the vehicle.

In embodiments, the electronic device (e.g., electronic device 106) may transmit, via a transceiver (e.g., transceiver 206), the set of distances and the set of digital images to an external processing server (e.g., external processing server 108). As discussed further herein, the external processing server may then determine the incentive-based message by correlating the set of distances with the set of digital images. For example, the external processing server may prioritize messages that are more relevant to the individuals closer to the vehicle, and thus, the electronic device.

As an illustration, the electronic device may transmit the set of distances and set of digital images indicative of the proximate vehicle to the external processing server. The server may then analyze a region surrounding the vehicle, as described above, and determine that there are 4 additional user devices in proximity of the vehicle. Two of the devices may be 0.1 miles from the vehicle, and the remaining two user devices may be 0.5 miles from the vehicle. The external processing server may then rank or otherwise associate the distances from the vehicle corresponding to each of the detected user devices. Based at least in part upon that association, the server may determine that because the proximate vehicle (and the corresponding user device) is closest to the vehicle (e.g., 10 feet from the right rear panel), the two devices 0.1 miles away are second closest to the vehicle, and the two devices 0.5 miles away are furthest from the vehicle, that the two furthest devices represent users that are the least likely to view the displayed message. Correspondingly, the server may determine that the two devices 0.1 miles away from the vehicle are less likely to view the displayed message than the proximate vehicle. In response, the server may determine an incentive-based message that is primarily relevant to the user(s) of the user device(s) corresponding to the proximate vehicle, and that is less relevant to the users of the remaining user devices. Similarly, if the server determines that the two devices 0.1 miles away are likely to view the displayed message, the server may increase, decrease, or otherwise modify a display time associated with the incentive-based message, as described further herein, to allow the users of those user devices a better opportunity to view the incentive-based message.

The method 400 continues at block 406 by determining an incentive-based message based at least in part upon the vehicle profile data and the set of user devices. A computer processor may determine the incentive-based message based at least in part upon a stored selection of messages (e.g., stored in database 210 and/or message database 232), the computer processor may receive an incentive-based message from an external source (e.g., message provider device 112), or the computer processor may retrieve a relevant message from an external source (e.g., external databases 114). For example, the computer processor may analyze the vehicle profile data and the set of user devices (e.g., the set of user device data) to determine a set of tags representative of the set of individuals indicated in the vehicle profile data and the set of user devices. This set of tags may include data corresponding to any of the information indicated herein, including vehicle location, time of day, weather, individual ages, individual genders, individual heights, individual weights, individual ethnic indicators, and/or any other suitable demographic indication. Using this set of tags, the computer processor may determine an incentive-based message by associating the set of tags included in the vehicle profile data and the user device data with the corresponding tags included in each of the stored messages. The stored message that includes the most tags corresponding with the set of tags included in the vehicle profile data and the user device data may be selected for display. Block 406 may be performed by, for example, the external processing server 108 and/or the message provider device 112.

To illustrate, assume an electronic device (e.g., electronic device 106) generates vehicle profile data indicative of a first individual and a user electronic device (e.g., user electronic device 110) generates user device data indicative of a second individual. Further, assume the vehicle profile data indicates that the first individual is an adult male, and that the user device data indicates that the second individual is an adult female. Additionally, assume that both the vehicle profile data and the user device data include a time of day and a geographic location. Thus, adult female, time of day, and the geographic location of either the vehicle or the user device are the set of tags that may be included in the subsequent analysis. An external server (e.g., external processing server 108) may analyze this set of tags to determine an incentive-based message, and more specifically, an incentive-based message for adult females at the particular time of day and location. As an example, if the vehicle profile data and/or the user device data indicates that the adult female is at a location featuring a plurality of restaurants in the middle of the day, the external server may determine an incentive-based message related to lunch specials at a nearby restaurant. As an example, the incentive-based message may be associated with a business named “X restaurant” and may say “20% off all entrees at X restaurant,” thus offering a discounted price for goods associated with the business.

In embodiments, determining the incentive-based message to be displayed on the vehicle exterior includes training a vehicle profile model. Generally speaking, the vehicle profile model represents a neural network, convolutional neural network, and/or any other suitable machine learning algorithm or combination thereof designed to automatically and dynamically determine the incentive-based messages for display. A computer processor may train the vehicle profile model using (i) a plurality of previously obtained vehicle profile data, (ii) a set of previous user device data, (iii) a set of message data corresponding to a plurality of incentive-based messages, and/or any other suitable information or combination thereof. The plurality of previously obtained vehicle profile data may indicate any of the information disclosed herein, such as vehicle make, model, year, color, vehicle identification number (VIN), etc. In certain embodiments, the plurality of previously obtained vehicle profile data may also include a set of historical telematics data, a set of historical routes, an historical driving behavior pattern, a set of historical geographical locations, a set of historical maintenance records, and/or any other suitable historical data or combination thereof. The set of previous user device data may also include any of the information disclosed herein, such as a set of user names, a set of user ages, a set of user genders, a set of user weights, and/or any other suitable data or combination thereof. The set of message data may include any message or set of messages, and may correspond to the messages determined for each previously obtained vehicle profile data and each set of previous user device data, either together or separately.

Consequently, the computer processor may also obtain response rates for each set of message data. For example, the response rate for a first historical message may indicate that 3 users managed to locate and view the first historical message. The response rate for a second historical message may indicate that 50 users managed to locate and view the second historical message. Accordingly, these response rates may enable the computer processor to better train the vehicle profile model to recognize correlations between the various historical data (e.g., plurality of previously obtained vehicle profile data, set of previous user device data, and set of message data).

The computer processor may access the plurality of previously obtained vehicle profile data from memory, or may request such information from an external source (e.g., memory 204, 214, 236, external databases 114) via a transceiver (e.g., transceiver 206). As an example, if an electronic device (e.g., electronic device 106) is accessing the plurality of previously obtained vehicle profile data, the device 106 may obtain such information from memory 204 (if available), or may request such information from the memory 214 of the external processing server 108. Conversely, if an external processing server (e.g., external processing server 108) is accessing the plurality of previously obtained vehicle profile data, the server 108 may obtain such information from memory 214 (if available), or may request such information from the memory 204 of the electronic device 106.

Similarly, the computer processor may access the set of previous user device data from memory, or may request such information from an external source (e.g., memory 214, 226, 236). As an example, if the user electronic device 110 is accessing the set of previous user device data, the device 110 may obtain such information from memory 226 (if available), or may request such information from the memory 214 of the external processing server 108. Conversely, if the external processing server 108 is accessing the set of previous user device data, the server 108 may obtain such information from memory 214 (if available), or may request such information from the memory 226 of the user electronic device 110.

The computer processor may access the set of message data corresponding to a plurality of incentive-based messages from memory, or may request such information from an external source (e.g., memory 214, 236). As an example, if the message provider device 112 is accessing the plurality of incentive-based messages, the device 112 may obtain such information from memory 236 (if available), or may request such information from the memory 214 of the external processing server 108. Conversely, if the external processing server 108 is accessing the plurality of incentive-based messages, the server 108 may obtain such information from memory 214 (if available), or may request such information from the memory 236 of the message provider device 112.

Thus, once the various historical data (e.g., plurality of previously obtained vehicle profile data, set of previous user device data, and set of message data) is obtained, a computer processor may execute instructions to train the vehicle profile model to recognize correlations between each distinct set of data. The model may recognize, for example, that a first incentive-based message displayed based at least in part upon user device data indicating a large number of male users received a correspondingly high viewership (e.g., a large percentage of the males notified of the display of the incentive-based message managed to view the message). The model may conclude that incentive-based messages similar to the first incentive-based message should be preferentially displayed when received user device data indicates a large number of male users. Similarly, the vehicle profile model may make any similar correlation between any pair or grouping of all the collected various historical data (e.g., plurality of previously obtained vehicle profile data, set of previous user device data, and set of message data).

Correspondingly, in embodiments, the computer processor may receive a request from a vehicle (e.g., vehicle 102) to display an incentive-based message. For example, the vehicle may transmit the request via the transceiver 206 of the electronic device 106. Moreover, the vehicle may transmit such a request periodically, at specific times each day, upon user input to transmit the request, and/or in response to any other suitable configuration or combination thereof. Included in the request, may be the vehicle profile data associated with the vehicle. The server may apply the vehicle profile model to the set of vehicle profile data to generate a vehicle score. For example, the device 106 may periodically (e.g., every several seconds, minutes, hours, days, weeks, etc.) acquire and analyze data associated with the vehicle environment, and/or may perform these functions upon user request. Additionally, the device 106 may perform the acquisition and analysis functions upon a user's acceptance of an offer to display an incentive-based message. For example, the external processing server 108, user electronic device 110, and/or the message provider device 112 may periodically or upon receipt of data indicative of an opportune moment to provide an incentive-based message (e.g., the vehicle is approaching a store location associated with a message provider) transmit a push notification or other indication of such incentive-based message to the electronic device 106. The electronic device 106 may display such notification to a user directly, or may further transmit such notification to the user's vehicle (e.g., vehicle 102) for display on an internal user interface associated with the vehicle 102 or the user's mobile device.

It is to be understood that the computer processor may alternatively or additionally receive a request from a message provider device (e.g., message provider device 112) requesting that an incentive-based message related to their products and/or services and a notification to user devices be sent by the computer processor. Similarly, the computer processor may alternatively or additionally receive a request from a user electronic device (e.g., user electronic device 110) requesting that the user receive an incentive-based message. Accordingly, the computer processor may initiate the method 400 or any portion thereof based at least in part upon a request, signal, or other communication received from any of the vehicle (e.g., via the electronic device), a user electronic device, a message provider device, and/or the computer processor may spontaneously and/or periodically execute instructions to perform the method 400 or any portion thereof.

The vehicle score may represent an assessment of how appealing the vehicle is for prospective incentive-based messaging entities. The vehicle score may additionally or alternatively represent the types of incentive-based messages that the vehicle profile model presumes would be suitable for the vehicle, and/or any other type of indication or combination thereof. For example, the vehicle profile data may indicate that the vehicle is routinely located near and/or among business professionals (e.g., a city environment), such that the vehicle would be an ideal candidate for incentive-based messages associated with products, services, and/or other areas that appeal to business professionals. Thus, the vehicle profile model may generate a vehicle score for the vehicle that indicates a high appeal for incentive-based messaging entities providing incentive-based messages for business professionals.

However, in embodiments, the vehicle profile model may also generate the vehicle score in relation to a vehicle score threshold. For any vehicle score that does not meet or exceed the threshold, the computer processor may not execute instructions to transmit an incentive-based message for display on the vehicle. The vehicle profile model may also generate a plurality of vehicle scores, such that each generated vehicle score corresponds to as unique sector of incentive-based messaging. In accordance with the above example, the vehicle profile model may determine that the vehicle is an ideal candidate for displaying incentive-based messages for business professionals. By contrast, the vehicle profile model may simultaneously determine that the vehicle is a less than ideal candidate for displaying incentive-based messages intended for children. Thus, the vehicle profile model may generate the high vehicle score related to incentive-based messaging entities providing incentive-based messages for business professionals, and may generate a low vehicle score related to incentive-based messaging entities providing incentive-based messages for children. Accordingly, the vehicle profile model may generate any suitable number of vehicle scores, and may subdivide the vehicle scores in any suitable fashion to adequately indicate the appeal of the vehicle for a particular sector of incentive-based messaging.

In an instance where the computer processor determines that the vehicle score satisfies the threshold vehicle score, the one or more processors may be further configured to receive a set of user device data from each respective user device of the set of user devices. Generally, the computer processor may conclude that because the vehicle score satisfies the threshold vehicle score, that the processor will transmit an incentive-based message for display on an electronic device of the vehicle, assuming there are device users within a reasonable viewing distance from the vehicle. Hence, the computer processor may analyze the data associated with the vehicle environment to determine one or more users and receive the set(s) of user device data. The processor may then apply the vehicle profile model to determine an incentive-based message for display on the vehicle exterior based at least in part upon the vehicle profile data and the set of user device data.

In embodiments, the computer processor may also determine one or more of (i) a benefit or (ii) an incentive associated with a policy of the vehicle in exchange for displaying the incentive-based message. Thus, when the computer processor determines an incentive-based message for display, the computer processor may also determine the benefit or incentive to be applied or otherwise associated with a vehicle policy associated with the display vehicle (e.g., vehicle 102). For example, the computer processor may determine an incentive-based message for display on the vehicle exterior that may be viewed by a large number of people. In this case, the computer processor may additionally determine that the vehicle policy associated with the display vehicle will receive a correspondingly large reduction in premium, cost, and/or any other suitable adjustment to the vehicle policy in return for displaying the message. In this manner, the systems and methods of the present disclosure allow vehicle drivers to achieve more favorable policy rates in exchange for participation in an incentive-message display program, leading to higher overall customer satisfaction.

In embodiments, the computer processor (e.g., external processing server 108) determines the incentive-based message by correlating the set of distances captured by the proximity sensor with the set of digital images captured by the image sensor. For example, the set of digital images may indicate a set of proximate vehicles (e.g., vehicle 304a). The set of proximate vehicles indicated in the set of digital images may be displaced at various distances from the vehicle, as will be correspondingly indicated in the set of distances. The computer processor may determine the incentive-based message by determining a message that is more relevant to the individuals with a smaller associated distance in the set of distances.

To illustrate, assume there are two proximate vehicles closer to the vehicle than two other proximate vehicles, as may be indicated in the set of distances. The server may analyze the distances in the set of distances to make this determination, and correspondingly weight the remaining data associated with the closer proximate vehicles more heavily than the remaining data associated with the farther proximate vehicles when making the incentive-based message determination. Thus, the server may determine an incentive-based message that is relevant to some and/or all proximate vehicles identified in the data associated with the vehicle environment, but that is more relevant to the closer proximate vehicles.

In embodiments, determining the incentive-based message comprises conducting an on-line auction and bidding process. The on-line auction and bidding process may include analyzing one or more of (i) a driving behavior pattern, (ii) a vehicle telemetry indicator, (iii) a current route traveled by the vehicle, (iv) a current roadway traveled by the vehicle, (v) an historical route traveled by the vehicle, (vi) an historical roadway traveled by the vehicle, (vii) a geographic indicator corresponding to the vehicle's position, (viii) a traffic indicator, or (ix) a weather indicator (collectively referenced herein as “auction impact indicators”). Moreover, the auction impact indicators may also include the vehicle score, determined by the vehicle profile model. The on-line auction and bidding process may take place in real-time (e.g., as the vehicle 102 drives during a vehicle trip) or prior to the vehicle trip.

For example, the on-line auction and bidding process may involve a number of prospective incentive-based message providers (e.g., companies, individuals, advertisers). The prospective incentive-based message providers may participate in the on-line auction, via their respective message provider devices 112, by bidding on durations corresponding to a vehicle (e.g., vehicle 102). The durations may represent periods during which the winning prospective message provider's message will be displayed on the corresponding vehicle. The periods may be divided into hours, minutes, seconds, etc. and may include various other indications. In embodiments, the durations may correspond to locations where the vehicle is currently located and/or has previously driven.

To illustrate, assume an on-line auction takes place for displaying incentive-based messages on a vehicle, in accordance with various embodiments herein. The system (e.g., 100, 200) may host prospective message providers on a server (e.g., auction host server 108) through the network (e.g., network 116) via their respective message provider devices (e.g., message provider device 112). The auction host server may provide durations corresponding to periods of time when a prospective message provider's incentive-based message would be displayed on the vehicle. In embodiments, the auction host server may provide one, some, or all of the auction impact indicators to prospective message providers before, during, or after the on-line auction. The auction host server may receive bids from the prospective message providers corresponding to the various durations, and the highest bid will win the duration for displaying that prospective message provider's incentive-based message.

As an example, assume the on-line auction referenced above takes place for the vehicle. The auction host server may display the durations to be auctioned for review by the prospective message providers on their respective message provider devices. As mentioned above, the durations may include timestamps indicating the periods of time during a day when the winning bidder's incentive-based message would be displayed. Moreover, the durations may include geotagged locations (e.g., country, state/province, county/parish, city, town, neighborhood, street address, postal code, etc.) indicating where the vehicle is likely to be at the identified time period. The auction host server may receive the geotagged locations via Global Positioning System (GPS) data and/or any other suitable location data.

The auction may include a duration from 2:30 PM to 3:30 PM, and the duration may indicate, for example, that the vehicle is likely to be in a carpool line at a local elementary school at 3:00 PM on weekdays. The auction may also include a duration from 5:30 PM to 6:30 PM, and the duration may indicate, for example, that the vehicle is likely to be on a busy downtown street at 6:00 PM on weekends. The 2:30-3:30 PM duration may receive more bids from prospective message providers targeting school age children, parents, teachers, etc. Correspondingly, the 5:30-6:30 PM duration may receive more bids from prospective message providers targeting middle aged individuals, business professionals, etc. By contrast, the auction impact indicators may detract from the value of a duration. For example, a duration from 1:00 AM to 2:00 AM in a sparsely populated area may not attract much interest from prospective message providers because the viewership is likely to be minimal.

In embodiments, the auction host server may set the opening bid prices for the durations in an auction based at least in part upon the auction impact indicators. As discussed herein, the auction impact indicators may affect the number of bids attributable to a duration. Thus, certain auction impact indicators may correspond to known positive impacts on the auction (e.g., would facilitate more bids and/or a higher overall winning bid), and other auction impact indicators may correspond to known negative impacts on the auction (e.g., would facilitate fewer bids and/or a lower overall winning bid). To account for such known impacts, the auction host server may generate an auction profile for a vehicle and/or a driver.

The auction host server may include one, some, or all of the auction impact indicators when generating the auction profile. Moreover, the auction host server may generate an auction profile rating to quickly indicate the attractiveness of displaying messages on a vehicle 102 and/or with a driver, similar to the vehicle score that may be included in the auction impact indicators. In one example, the auction host server may analyze the driving behaviors of the driver to determine whether the driver generally drives in a cautious or risky manner. If, as an illustration, the driver consistently makes sudden movements with the vehicle (e.g., turns at high speeds, changes lanes quickly, accelerates rapidly from a stop, etc.), generally drives in a risky manner (e.g., drives at night, drives in hazardous weather conditions, does not activate turning signals, drives over the speed limit), and/or otherwise drives in a manner that would produce minimal message display impact (e.g., drives in low population areas) then the auction host server may lower the driver's auction profile rating to suggest that the driver may not be an ideal candidate for a prospective message provider. By contrast, if a driver consistently drives at or under the speed limit and/or makes gentle, controlled movements with the vehicle, then the auction host server may raise the driver's auction profile rating to suggest that the driver is an ideal candidate for a prospective message provider.

In embodiments, the auction host server may actively update the generated auction profiles in real-time, and may display reasons why a vehicle and/or driver's profile rating was raised or lowered. For example, if a vehicle's profile rating is lowered 15 points during an auction, the auction host server may display an indication that the vehicle was recently involved in an accident, and thus may be a less desirable candidate for incentive-based message display. Displaying this information facilitates a more informed bidding decision for the prospective message providers, and may increase the overall functionality of the system (e.g., 100, 200).

As an example, if the auction host server lowers a driver's profile rating based at least in part upon driving at night, prospective message providers in the automotive lighting industry, handheld lighting industry, and the like may nonetheless be incentivized to bid on late night durations associated with that driver due to the increased likelihood of viewership in conditions relevant to their products/services. Similarly, if the auction host server raises a vehicle's profile rating because the vehicle is a high-value sports car that is likely to attract a higher amount of attention than an average vehicle, prospective message providers in the automotive enhancement industries, sports racing industries, and the like may be incentivized to bid on durations associated with the vehicle 102 due to the increased likelihood of viewership from clientele with interest in their respective markets (e.g., performance car enthusiasts, car racing enthusiasts, etc.).

The method 400 continues at block 408 by transmitting the incentive-based message to the vehicle. Specifically, the server (e.g., external processing server 108, message provider device 112) may transmit the incentive-based message to the electronic device (e.g., electronic device 106). As mentioned herein, in embodiments, the electronic display (e.g., electronic display 104) and the electronic device may be communicatively connected, but physically separate elements. For example, the electronic device may be located in the vehicle interior (e.g., as a connected component of the engine control unit (ECU)), while the electronic display is disposed on the vehicle exterior (e.g., the rear bumper). Thus, additionally or alternatively, the external processing server may transmit the targeted message to the electronic display directly. Block 408 may be performed by, for example, the external processing server 108 and/or the message provider device 112.

The method 400 continues at block 410 by transmitting the notification to the set of user devices. For example, and as discussed above, the notification may include data corresponding to the incentive-based message transmitted to the vehicle for display. The notification may indicate to a user of the user device what message provider provided the message, what incentive is included as a part of the incentive-based message, where and how the incentive included in the message is redeemable, how long the user has to locate the vehicle and view the incentive-based message, and/or any other suitable information of combination thereof. Block 410 may be performed by, for example, the external processing server 108 and/or the message provider device 112.

In embodiments, the user devices are configured to receive the notification through an active connection to an application. The application, as discussed above, may be a common application that all user devices included in the set of user devices have currently installed on the device. The application may also represent a plurality of applications that are supported by the systems and methods disclosed herein. For example, the incentive-based message display system of the present disclosure may include messages for the plurality of applications, interact with the servers associated with the plurality of applications, and/or otherwise support each of the applications included in the plurality of applications. The active connection may indicate the user device maintaining an active connection to the Internet via any suitable connection (e.g., Wi-Fi, Bluetooth, roaming data, etc.), and/or a user currently using the application by having the application open on the user device and interacting with the application.

In any event, the one or more processors may be further configured to obtain location data corresponding to (i) the vehicle and (ii) each user device maintaining the active connection. The location data may include at least one of a global positioning system (GPS) data or a geotagged signal. The one or more processors may be configured to determine the respective distance of each user device from the vehicle by comparing the location data corresponding to the vehicle to the location data corresponding to each user device. Thus, in addition to the methods previously described to determine distances of user devices from the vehicle, the one or more processors may also retrieve location data directly from the user devices by communicating with the user devices to retrieve location data from them via the active connection of the user devices (e.g., to network 116).

The method 400 continues at block 412 by displaying the incentive-based message for viewing by a set of individuals associated with the set of user devices. Specifically, the electronic device will display the incentive-based message on the electronic display for viewing by the set of individuals associated with the set of user devices. Accordingly, the set of individuals may attempt to locate and view the incentive-based message, and may receive the message contained therein along with the associated incentives. Block 412 may be performed by, for example, the electronic display 104.

In embodiments, the computer processor may receive an indication from each user device of the set of user devices corresponding to whether the respective user device satisfies a geographical threshold with respect to the vehicle. As such, and responsive to receiving an indication that at least one user device satisfied the geographical threshold with respect to the vehicle, the computer processors may transmit an incentive message to the respective user device indicating a received incentive. For example, assume a proximate user device to the vehicle (e.g., vehicle 102) receives a notification indicating the incentive-based message displayed on the vehicle. The user may view the notification and attempt to locate the vehicle displaying the incentive-based message. In the event where the user successfully locates the vehicle, the user device may transmit a signal indicating the user device's position with respect to the vehicle. This signal may arrive at the computer processor, which subsequently will determine whether the user device has satisfied the geographical threshold for receiving the listed incentive from the incentive-based message.

To illustrate, the geographical threshold may be 100 feet, and may further specify a relevant direction (e.g., within 100 feet from behind the vehicle, within 100 feet from the driver's side of the vehicle, etc.). Thus, if the computer processor determines that the user device's signal indicates that the user device is within 100 feet from the rear of the vehicle, that the user device (and by proxy, the user) has satisfied the geographical threshold to receive the listed incentive in the incentive-based message. Consequently, the geographical threshold may include any other relevant qualifications, such as maintaining an active connection to the Internet, keeping the notification open on the user device, and/or any other suitable stipulation or combination thereof for the geographical threshold to be satisfied.

As previously discussed in reference to the on-line auction process, and in embodiments, the electronic display may display the incentive-based message for specified durations. Thus, the electronic display may receive a plurality of targeted messages for display during a plurality of durations. For example, the external processing server may determine that several messages may be relevant to the set of individuals associated with the set of user devices.

In one instance, the external processing server may receive data (e.g., data associated with the vehicle environment) indicating that the vehicle is slowly moving (e.g., moving through traffic), and thus may be exposed to a similar set of individuals over a short period of time. In response, the external processing server may conduct an on-line auction to facilitate displaying incentive-based messages to the set of individuals over a short-term set of durations (e.g., a set of five minute durations over the course of an hour).

Alternatively, the external processing server may receive data indicating that the vehicle is stationary (e.g., parked in a parking lot), and thus may be exposed to a similar set of individuals over a long period of time. In response, the external processing server may conduct an on-line auction to facilitate displaying incentive-based messages to the set of individuals over a long-term set of durations (e.g., a set of two hour durations over the course of a day).

In embodiments, and responsive to displaying the incentive-based message on the electronic display, the computer processor (e.g., electronic device 106) may determine one or more of (i) a benefit or (ii) an incentive associated with a policy of the vehicle in exchange for displaying the targeted message. For example, and as previously discussed, the computer processor may determine that a user has satisfactorily displayed the incentive-based message (e.g., the incentive-based message was displayed for the intended duration), and thus qualifies for a benefit associated with their (or their vehicle's) insurance policy (e.g., lower premium, lower deductible, elevated coverage level, etc.). Correspondingly, the computer processor may transmit a notification to the external processing server indicating the intended benefit. The external processing server may then access the insurance policy and apply the benefit to the insurance policy. In this way, the system (e.g., 100, 200) facilitates both incentive-based message display for those with user devices configured to receive the notifications, and an improved insurance incentive program whereby users (e.g., customers) have increased satisfaction through lower insurance rates and higher levels of service.

In embodiments, the computer processor (e.g., electronic device 106) may transmit a periodic update for display on a user interface (e.g., user interface 222) of the vehicle to provide one or more beneficial driving behaviors intended to impact a performance of the vehicle in the on-line auction and bidding process. For example, and as discussed herein with respect to the on-line auction and bidding process, a driver may consistently drive over the speed limit, which may negatively impact their profile rating, as viewed by prospective message providers. Thus, the computer processor may transmit an update to the vehicle's user interface to provide a beneficial driving behavior (e.g., an update suggesting that the user slow down). Additionally, the computer processor may concurrently display the predicted profile rating increase associated with the beneficial driving behavior indicated in the transmitted update. To illustrate, the update may suggest that the driver slow down, and may additionally indicate that should the driver slow down, the associated profile rating will increase by 5 points. Thus, the system (e.g., 100, 200) may facilitate better driving habits, and the vehicle's subsequent performance in the on-line auction and bidding process may be improved, by linking good driving behavior with monetary incentives (e.g., message display revenue, insurance benefits/incentives, etc.). As previously discussed, it is to be appreciated that any suitable scoring system or metric may be used for the profile rating.

It is to be understood that a message provider device (e.g., message provider device 112) may provide all, some, or none of the functionality described herein in reference to the method 400. For example, an electronic device (e.g., electronic device 106) and a user electronic device (e.g., user electronic device 110) may receive all, none, or a portion of the communications described in the method 400, such as an incentive-based message, from the message provider device.

By providing systems and methods that allow facilitating targeted advertising on automobiles as described herein, various advantages are achieved. For example, the systems and methods provide and/or are implemented through the use of a device(s) that provide information particularly suited for use with other features of the systems and methods to facilitating incentive-based advertising on automobiles. Notably, the systems and methods provide a seamless, real-time solution to detecting data associated with a vehicle environment, determining a set of user devices configured to receive a notification corresponding to the incentive-based message, determining an incentive-based message from the vehicle profile data and the set of user devices, transmitting the incentive-based message and the notifications, and displaying the incentive-based message.

Moreover, the methods and systems of the present disclosure provide additional advantages such as displaying readable messages that have a limited distraction potential for motorists and are relevant to those viewing the messages. The messages displayed on the systems described herein are more readable than those of conventional digital displays because the messages are displayed on vehicles that are closer to both pedestrians and proximate vehicles than the conventional display devices (e.g., billboards). Placing the targeted messages on proximate vehicles reduces distraction potential for other motorists and pedestrians alike because the messages keep their focus nearer to their local surroundings (e.g., active roadways, sidewalks, crosswalks, etc.) instead of the elevated positions of conventional display devices that remove their focus from such surroundings. Hence, the systems of the present application are able to effectively communicate the incentive-based messages, and may reduce the risk of traffic accidents and other roadway hazards by eliminating the distracting potential of conventional display devices. The messages are also more relevant than the static, general messages on conventional display devices because they are dynamically updated and targeted for the proximate viewing audience (e.g., proximate motorists and pedestrians).

In this manner, the systems of the present application provide a technical improvement to the field of roadway message display. The systems provide a real-time message delivery system capable of determining an incentive-based message related to proximate drivers, pedestrians, and/or other users or combinations thereof. Accordingly, the systems of the present application readily and effectively incorporate and present time-sensitive messages (e.g., incentive-based messages) in a format and display location that is both relevant and proximate to users. Thus, the systems and methods of the present application also improve the functioning of the devices used to facilitate the above-described advantages. For example, user electronic devices utilizing the systems and methods of the present application may dynamically request notifications, receive notifications, transmit successful requests, and/or receive benefits associated with an incentive-based message displayed in accordance with the systems and methods of the present application, or any combination thereof, to achieve a more active/responsive connection with external devices regarding the exchange of incentive-based message communications. Other advantages will be recognized by one of ordinary skill in the art in light of the teaching and disclosure herein.

As will be apparent from the above description, and as should be appreciated with respect to all examples presented herein, the functions or operations shown in FIG. 4 may be performed in any suitable order, any desired number of times, and/or with any suitable variation to the particular order and/or combination shown so as to achieve a desired result, such as a desired manner of facilitating incentive-based message display on automobiles.

### IV. Examples of Additional Considerations

The following additional considerations apply to the foregoing discussion. Throughout this specification, plural instances may implement functions, components, operations, or structures described as a single instance. As noted above, although individual functions and instructions of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The methods described in this application may include one or more functions or routines in the form of non-transitory computer-executable instructions that are stored in a tangible computer-readable storage medium and executed using a processor of a computing device (e.g., the electronic display 104, the electronic device 106, the external processing server 108, the user electronic device 110, the message provider device 112, and/or any other computing devices within the example system (e.g., 100, 200) in any suitable combination). The routines may be included as part of any of the modules described in relation to FIGS. 1 and/or 2 or as part of a module that is external to the system illustrated by FIGS. 1 and/or 2. For example, the methods or portions thereof may be part of a browser application(s) or an application(s) running on any of the devices in the example system (e.g., 100, 200) as a plug-in or other module of the browser application. Further, the methods may be employed as “software-as-a-service” to provide, for example, the electronic display 104, the electronic device 106, the external processing server 108, the user electronic device 110, the message provider device 112, and/or any other computing devices with access to the example system (e.g., 100, 200).

Additionally, certain aspects are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain functions). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of example functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or functions described herein may be at least partially processor-implemented. For example, at least some of the functions of a method may be performed by one or more processors or processor-implemented hardware modules. The performance of certain of the functions may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic region (e.g., within a home environment, an office environment, or a server farm). In other example embodiments, the one or more processors or processor-implemented modules may be distributed across a number of geographic regions.

Still further, the figures depict preferred embodiments of example systems (e.g., 100, 200) and methods for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for systems and methods for providing incentive-based messages on automobiles. Thus, while particular embodiments and applications have been illustrated and described, it is to be understood that the disclosed embodiments are not limited to the precise construction and components disclosed herein.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

1. A system for displaying incentive-based messages on an external surface of a vehicle, the system comprising:
an electronic display disposed on the external surface of the vehicle and associated with a field of view that indicates an area within which one or more sensors disposed at the electronic display are configured to capture data;
a transceiver;
one or more memories; and
one or more processors interfacing with the transceiver, the one or more memories, and the electronic display of the vehicle, and configured to:
obtain a set of vehicle profile data corresponding to the vehicle,
identify a first set of user devices disposed in a first set of vehicles and based at least in part upon a respective distance of each user device of the first set of user devices from the vehicle at a first time, each user device of the first set of user devices configured to receive a notification corresponding to an incentive-based message, each vehicle of the first set of vehicles being different from the vehicle and determined to be within the field of view of the electronic display,
determine a first incentive-based message based at least in part upon the set of vehicle profile data and the first set of user devices,
transmit the first incentive-based message to the vehicle,
transmit a first notification corresponding to the first incentive-based message to each user device of the first set of user devices,
cause the electronic display to display the first incentive-based message for viewing by a first set of individuals associated with the first set of user devices.

2. The system of claim 1, wherein the one or more processors is further configured to:
receive an indication from each user device of the first set of user devices, the indication corresponding to whether a respective user device satisfies a geographical threshold with respect to the vehicle; and
responsive to receiving an indication that at least one user device satisfies the geographical threshold with respect to the vehicle, transmit the first incentive-based message to the respective user device indicating a received incentive.

3. The system of claim 1, wherein the set of vehicle profile data includes at least one selected from a group consisting of (i) a set of telematics data, (ii) a current route, (iii) a driving behavior pattern, (iv) an historical route, (v) a geographical location, (vi) a set of current traffic information, (vii) a set of historical maintenance records, (viii) a set of current weather conditions, (ix) a weather forecast, (x) a current date, and (xi) a current time; wherein each user device of the first set of user devices is associated with a set of user device data; and wherein the set of user device data includes at least one selected from a group consisting of (i) a vehicle type, (ii) a user name, (iii) a user age, (iv) a user gender, and (v) a user weight.

4. The system of claim 3, wherein the one or more processors is further configured to:
train a vehicle profile model using (i) a plurality of previously obtained vehicle profile data, (ii) a set of previous user device data, and (iii) a set of message data corresponding to a plurality of incentive-based messages;
receive, from the vehicle, a request to display an incentive-based message;
apply the vehicle profile model to the set of vehicle profile data to generate a vehicle score; and
determine whether the vehicle score satisfies a threshold vehicle score.

5. The system of claim 4, wherein, responsive to determining that the vehicle score satisfies the threshold vehicle score, the one or more processors is further configured to:
receive a set of user device data from a respective user device of the first set of user devices; and
apply the vehicle profile model to determine the incentive-based message based at least in part upon the set of vehicle profile data and the set of user device data.

6. The system of claim 1, wherein the first set of user devices are configured to receive the notification through an active connection to an application, and the one or more processors is further configured to:
obtain location data corresponding to (i) the vehicle and (ii) each user device of the first set of user devices maintaining the active connection, wherein the location data includes at least one selected from a group consisting of a global positioning system (GPS) data and a geotagged signal; and
determine the respective distance of the each user device of the first set of user devices from the vehicle by comparing the location data corresponding to the vehicle to the location data corresponding to the each user device.

7. The system of claim 1, wherein the one or more processors is further configured to determine at least one selected from a group consisting of (i) a benefit and (ii) an incentive associated with a policy of the vehicle in exchange for displaying the first incentive-based message.

8. A computer-implemented method for displaying incentive-based messages on an external surface of a vehicle, the method comprising:
obtaining, by one or more processors, a set of vehicle profile data corresponding to the vehicle,
identifying, by the one or more processors, a first set of user devices disposed in a first set of vehicles and based at least in part upon a respective distance of each user device of the first set of user devices from the vehicle, each user device of the first set of user devices configured to receive a notification corresponding to an incentive-based message, wherein each vehicle of the first set of vehicles is different from the vehicle and determined to be within a field of view of an electronic display disposed on the external surface of the vehicle, wherein the field of view is associated with the electronic display and indicates an area within which one or more sensors disposed at the electronic display are configured to capture data,
determining, by the one or more processors, a first incentive-based message based at least in part upon the set of vehicle profile data and the first set of user devices,
transmitting, by the one or more processors via a transceiver, the first incentive-based message to the vehicle,
transmitting, by the one or more processors via the transceiver, a first notification corresponding to the first incentive-based message to each user device of the first set of user devices,
displaying, by the electronic display, the first incentive-based message for viewing by a first set of individuals associated with the first set of user devices.

9. The computer-implemented method of claim 8, further comprising:
receiving, by the one or more processors via the transceiver, an indication from each user device of the first set of user devices corresponding to whether a respective user device satisfies a geographical threshold with respect to the vehicle; and
responsive to receiving an indication that at least one user device satisfies the geographical threshold with respect to the vehicle, transmitting, by the one or more processors via the transceiver, the first incentive-based message to the respective user device indicating a received incentive.

10. The computer-implemented method of claim 8, wherein the set of vehicle profile data includes at least one selected from a group consisting of (i) a set of telematics data, (ii) a current route, (iii) a driving behavior pattern, (iv) an historical route, (v) a geographical location, (vi) a set of current traffic information, (vii) a set of historical maintenance records, (viii) a set of current weather conditions, (ix) a weather forecast, (x) a current date, and (xi) a current time; wherein each user device of the first set of user devices is associated with a set of user device data; and wherein each set of user device data includes at least one selected from a group consisting of (i) a vehicle type, (ii) a user name, (iii) a user age, (iv) a user gender, and (v) a user weight.

11. The computer-implemented method of claim 10, further comprising:
training, by the one or more processors, a vehicle profile model using (i) a plurality of previously obtained vehicle profile data, (ii) a set of previous user device data, and (iii) a set of message data corresponding to a plurality of incentive-based messages;
receiving, from the vehicle, a request to display an incentive-based message;
applying, by the one or more processors, the vehicle profile model to the set of vehicle profile data to generate a vehicle score; and
determining, by the one or more processors, whether the vehicle score satisfies a threshold vehicle score.

12. The computer-implemented method of claim 11, wherein, responsive to determining that the vehicle score satisfies the threshold vehicle score, the method further comprises:
receiving, by the one or more processors via the transceiver, a set of user device data from each respective user device of the first set of user devices; and
applying, by the one or more processors, the vehicle profile model to determine the first incentive-based message based at least in part upon the set of vehicle profile data and the set of user device data.

13. The computer-implemented method of claim 8, wherein the first set of user devices are configured to receive the notification through an active connection to an application, and the method further comprises:
obtaining, by the one or more processors via the transceiver, location data corresponding to (i) the vehicle and (ii) each user device maintaining the active connection, wherein the location data includes at least one selected from a group consisting of a global positioning system (GPS) data and a geotagged signal; and
determining, by the one or more processors, the respective distance of the each user device of the first set of user devices from the vehicle by comparing the location data corresponding to the vehicle to the location data corresponding to the each user device.

14. The computer-implemented method of claim 8, further comprising determining, by the one or more processors, at least one selected from a group consisting of (i) a benefit and (ii) an incentive associated with a policy of the vehicle in exchange for displaying the first incentive-based message.

15. A computer readable storage medium comprising non-transitory computer readable instructions stored thereon for displaying incentive-based messages on an external surface of a vehicle, wherein the instructions when executed on one or more processors cause the one or more processors to:
obtain a set of vehicle profile data corresponding to the vehicle,
identify a first set of user devices disposed in a first set of vehicles and based at least in part upon a respective distance of each user device of the first set of user devices from the vehicle, each user device of the first set of user devices configured to receive a notification corresponding to an incentive-based message, each vehicle of the first set of vehicles being different from the vehicle and determined to be within a field of view of an electronic display disposed on the external surface of the vehicle, the field of view being associated with the electronic display and indicating an area within which one or more sensors disposed at the electronic display are configured to capture data,
determine a first incentive-based message based at least in part upon the set of vehicle profile data and the first set of user devices,
transmit the first incentive-based message to the vehicle,
transmit a first notification corresponding to the first incentive-based message to each user device of the first set of user devices,
cause the electronic display to display the first incentive-based message for viewing by a first set of individuals associated with the first set of user devices.

16. The computer readable storage medium of claim 15, wherein the instructions further cause the one or more processors to:
receive an indication from each user device of the first set of user devices, the indication corresponding to whether a respective user device satisfies a geographical threshold with respect to the vehicle; and
responsive to receiving an indication that at least one user device satisfied the geographical threshold with respect to the vehicle, transmit the first incentive-based message to the respective user device indicating a received incentive.

17. The computer readable storage medium of claim 15, wherein the set of vehicle profile data includes at least one selected from a group consisting of (i) a set of telematics data, (ii) a current route, (iii) a driving behavior pattern, (iv) an historical route, (v) a geographical location, (vi) a set of current traffic information, (vii) a set of historical maintenance records, (viii) a set of current weather conditions, (ix) a weather forecast, (x) a current date, and (xi) a current time; wherein each user device of the first set of user devices is associated with a set of user device data; and wherein each set of user device data includes at least one selected from a group consisting of (i) a vehicle type, (ii) a user name, (iii) a user age, (iv) a user gender, and (v) a user weight.

18. The computer readable storage medium of claim 17, wherein the instructions further cause the one or more processors to:
train a vehicle profile model using (i) a plurality of previously obtained vehicle profile data, (ii) a set of previous user device data, and (iii) a set of message data corresponding to a plurality of incentive-based messages;
receive, from the vehicle, a request to display an incentive-based message;
apply the vehicle profile model to the set of vehicle profile data to generate a vehicle score; and
determine whether the vehicle score satisfies a threshold vehicle score.

19. The computer readable storage medium of claim 18, wherein,
responsive to determining that the vehicle score satisfies the threshold vehicle score, the instructions further cause the one or more processors to:
receive a set of user device data from a respective user device of the first set of user devices; and
apply the vehicle profile model to determine the incentive-based message based at least in part upon the set of vehicle profile data and the set of user device data.

20. The computer readable storage medium of claim 15, wherein the first set of user devices are configured to receive the notification through an active connection to an application, and the instructions further cause the one or more processors to:
obtain location data corresponding to (i) the vehicle and (ii) each user device of the first set of user devices maintaining the active connection, wherein the location data includes one of a global positioning system (GPS) data and a geotagged signal; and
determine the respective distance of the each user device of the first set of user devices from the vehicle by comparing the location data corresponding to the vehicle to the location data corresponding to the each user device of the first set of user devices.

21. A system for displaying incentive-based messages on an external surface of a vehicle, the system comprising:
an electronic display disposed on the external surface of the vehicle and associated with a field of view that indicates an area within which one or more sensors disposed at the electronic display are configured to capture data;
one or more memories; and
one or more processors coupled to the one or more memories, and the electronic display, and configured to:
obtain a set of vehicle profile data corresponding to the vehicle,
receive sensor data captured by the one or more sensors disposed at the electronic display, the sensor data comprising image data of an environment surrounding the vehicle,
identify a first set of user devices disposed in a first set of vehicles and based at least in part upon a respective distance from the vehicle at a first time, each user device of the first set of user devices configured to receive a notification corresponding to an incentive-based message, each vehicle of the first set of vehicles being different from the vehicle and determined to be within the field of view of the electronic display based upon the sensor data,
determine a first incentive-based message based at least in part upon the set of vehicle profile data and the first set of user devices,
transmit the first incentive-based message to the vehicle,
transmit a first notification corresponding to the first incentive-based message to each user device of the first set of user devices,
cause the electronic display to display the first incentive-based message for viewing by a first set of individuals associated with the first set of user devices, determine a second set of user devices disposed in a second set of vehicles and based at least in part upon a respective distance from the vehicle at a second time, each user device of the second set of user devices configured to receive a notification corresponding to an incentive-based message, each vehicle of the second set of vehicles being different from the vehicle and determined to be within the field of view of the electronic display,
determine a second incentive-based message based at least in part upon the set of vehicle profile data and the second set of user devices, the second incentive-based message being different from the first incentive-based message,
transmit the second incentive-based message to the vehicle,
transmit a second notification corresponding to the second incentive-based message to each user device of the second set of user devices, and
cause the electronic display to display the second incentive-based message for viewing by a second set of individuals associated with the second set of user devices.

22. The system of claim 21, wherein the one or more processors is further configured to:
receive an indication from each user device of the first set of user devices, the indication corresponding to whether a respective user device satisfies a geographical threshold with respect to the vehicle; and
responsive to receiving an indication that at least one user device satisfies the geographical threshold with respect to the vehicle, transmit the first incentive-based message to the respective user device indicating a received incentive.

23. The system of claim 21, wherein the set of vehicle profile data includes at least one selected from a group consisting of (i) a set of telematics data, (ii) a current route, (iii) a driving behavior pattern, (iv) an historical route, (v) a geographical location, (vi) a set of current traffic information, (vii) a set of historical maintenance records, (viii) a set of current weather conditions, (ix) a weather forecast, (x) a current date, and (xi) a current time; wherein each user device of the first set of user devices and the second set of user devices is associated with a set of user device data; and wherein the set of user device data includes at least one selected from a group consisting of (i) a vehicle type, (ii) a user name, (iii) a user age, (iv) a user gender, and (v) a user weight.

24. The system of claim 23, wherein the one or more processors is further configured to:
train a vehicle profile model using (i) a plurality of previously obtained vehicle profile data, (ii) a set of previous user device data, and (iii) a set of message data corresponding to a plurality of incentive-based messages;
receive, from the vehicle, a request to display an incentive-based message;
apply the vehicle profile model to the set of vehicle profile data to generate a vehicle score; and
determine whether the vehicle score satisfies a threshold vehicle score.

25. The system of claim 1, wherein the one or more processors are further configured to:
receive sensor data captured by the one or more sensors disposed at the electronic display, the sensor data comprising image data of an environment surrounding the vehicle;
wherein the first set of vehicles are determined to be within the field of view of the electronic display based at least in part upon the sensor data.

26. The system of claim 1, wherein the one or more processors are further configured to:
identify a second set of user devices disposed in a second set of vehicles and based at least in part upon a respective distance of each user device of the second set of user devices from the vehicle at a second time, each user device of the second set of user devices configured to receive a notification corresponding to an incentive-based message, each vehicle of the second set of vehicles being different from the vehicle and determined to be within the field of view of the electronic display,
determine a second incentive-based message based at least in part upon the set of vehicle profile data and the second set of user devices, the second incentive-based message being different from the first incentive-based message,
transmit the second incentive-based message to the vehicle,
transmit a second notification corresponding to the second incentive-based message to each user device of the second set of user devices, and
cause the electronic display to display the second incentive-based message for viewing by a second set of individuals associated with the second set of user devices.

27. The computer-implemented method of claim 8, further comprising:
identifying, by the one or more processors, a second set of user devices disposed in a second set of vehicles and based at least in part upon a respective distance of each user device of the second set of user devices from the vehicle, each user device of the second set of user devices configured to receive a notification corresponding to an incentive-based message, each vehicle of the second set of vehicles being different from the vehicle and determined to be within the field of view of the electronic display,
determining, by the one or more processors, a second incentive-based message based at least in part upon the set of vehicle profile data and the second set of user devices,
transmitting, by the one or more processors via a transceiver, the second incentive-based message to the vehicle,
transmitting, by the one or more processors via the transceiver, a second notification corresponding to the second incentive-based message to each user device of the second set of user devices, and
displaying, by the electronic display disposed on the external surface of the vehicle, the second incentive-based message for viewing by a second set of individuals associated with the second set of user devices.

28. The computer readable storage medium of claim 15, wherein the instructions further cause the one or more processors to:
identify a second set of user devices disposed in a second set of vehicles and based at least in part upon a respective distance of each user device of the second set of user devices from the vehicle at a second time, each user device of the second set of user devices configured to receive a notification corresponding to an incentive-based message, each vehicle of the second set of vehicles being different from the vehicle and determined to be within the field of view of the electronic display,
determine a second incentive-based message based at least in part upon the set of vehicle profile data and the second set of user devices, the second incentive-based message being different from the first incentive-based message,
transmit the second incentive-based message to the vehicle,
transmit a second notification corresponding to the second incentive-based message to each user device of the second set of user devices, and
cause the electronic display to display the second incentive-based message for viewing by a second set of individuals associated with the second set of user devices.
